(19) United States
(12) Patent Application Publication
(10) Pub. No.: US 2018/0275580 A1
(43) Pub. Date: Sep. 27, 2018

(54) IMAGE FORMING APPARATUS AND IMAGE FORMING SYSTEM

(71) Applicants: KABUSHIKI KAISHA TOSHIBA, Tokyo (JP); TOSHIBA TEC KABUSHIKI KAISHA, Tokyo (JP)

(72) Inventor: Takeshi WATANABE, Yokohama Kanagawa (JP)

(21) Appl. No.: 15/891,247

(22) Filed: Feb. 7, 2018

(30) Foreign Application Priority Data
Mar. 22, 2017 (JP) 2017-056217

(51) Int. Cl. G03G 15/00; G03G 15/01; G03G 15/16

(52) U.S. Cl. CPC G03G 15/5062; G03G 15/0131; G03G 15/16; G03G 2215/00409; G03G 15/55; G03G 15/6567; G03G 15/5025

(57) ABSTRACT

An image forming apparatus includes a reading unit with a fixed reading position and configured to read a first image on a sheet and detect a position of the first image. A toner image transfer unit is configured to transfer a toner pattern to the sheet at a fixed transfer position. The toner pattern corresponds to a second image to be disposed on the sheet with the first image. The toner image transfer unit is downstream of the reading unit along the sheet feeding path. A control unit calculates a timing for transfer of the toner pattern to the sheet according to the detected position of the first image on the sheet and controls the toner image transfer unit according to the calculated timing.

### CROSS-REFERENCE TO RELATED APPLICATION

This application is based upon and claims the benefit of priority from Japanese Patent Application No. 2017-056217, filed Mar. 22, 2017, the entire contents of which are incorporated herein by reference.

### FIELD

Embodiments described herein relate generally to an image forming apparatus and an image forming system.

### BACKGROUND

In the related art, decorative printing using special color toner such as a gold color, a silver color, a fluorescent color, or the like, is known. However, in order to perform such decorative printing, it is generally necessary to provide a new, additional toner cartridge, in addition to toner cartridges for the standard four colors of yellow, magenta, cyan, and black. It is thus necessary to provide five or more toner cartridges in series within a printing apparatus, and this make the apparatus large. A larger printing apparatus is a burden on a potential user when considering the requirements for apparatus installation area (footprint) and associated costs.

### DESCRIPTION OF THE DRAWINGS

FIG. 1 illustrates a configuration of an image forming system.

FIG. 2 is a diagram which illustrates one possible example of a main fixing unit.

FIG. 3 is a schematic block diagram which illustrates aspects of a main image forming apparatus.

FIG. 4 depicts aspects of a sub-image forming apparatus.

FIG. 5 is a schematic block diagram which illustrates functional aspects of the sub-image forming apparatus.

FIG. 6 is a diagram which illustrates an image forming distance and a transport distance.

FIG. 7 is a diagram which illustrates a distance between an end of a sheet and an original image.

FIG. 8 is a flowchart from a determination of adding to the adding in the sub-image forming apparatus.

FIG. 9 is a diagram which illustrates a state in which a sheet stops before reaching a sub-transfer unit.

### DETAILED DESCRIPTION

Embodiments provide an image forming apparatus and an image forming system which can perform decorative printing at a low cost.

According to one embodiment, a secondary image forming apparatus comprises a reading unit having a fixed reading position at which images on sheets moving along a sheet feeding path past the fixed reading position can be read. The reading unit is configured to read a sheet having a first image thereon and detect a position of the first image on the sheet. A toner image transfer unit has a fixed transfer position on the sheet feeding path and is configured to transfer a toner pattern to the sheet at the fixed transfer position. The toner pattern corresponds to a second image that is to be disposed on the sheet with the first image. The toner image transfer unit is downstream of the reading unit along the sheet feeding path. A control unit is configured to calculate a timing for transfer of the toner pattern to the sheet by the toner image transfer unit according to detected position of the first image on the sheet, and control the toner image transfer unit according to the calculated timing.

Hereinafter, an image forming apparatus and an image forming system according to example embodiments will be described with reference to drawings.

### First Embodiment

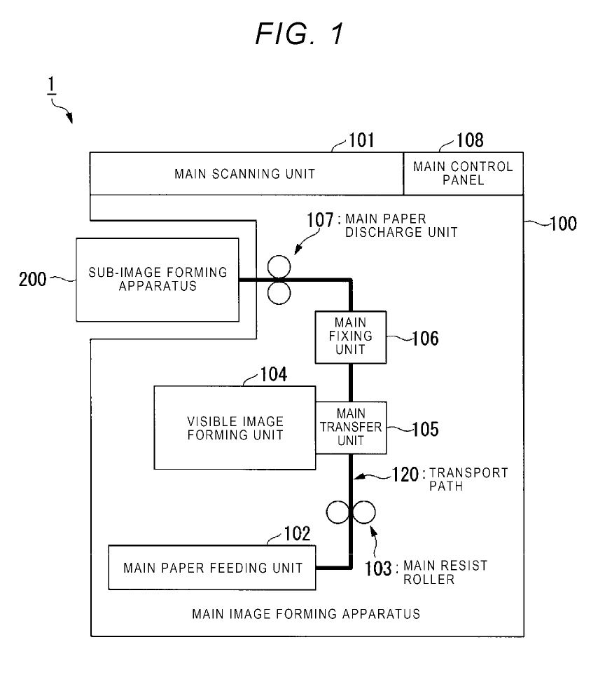

FIG. 1 is a configuration diagram which illustrates a configuration of an image forming system 1 according a first embodiment. The image forming system 1 includes a main image forming apparatus 100 and a sub-image forming apparatus 200. The main image forming apparatus 100 is one possible example of a first image forming apparatus, and the sub-image forming apparatus 200 is one possible example of a second image forming apparatus. A sheet of paper or the like is transported to a sub-paper feeding unit 201 of the sub-image forming apparatus 200 via a main paper discharge unit 107 of the main image forming apparatus 100 from the main paper feeding unit 102 of the main image forming apparatus 100, and is transported to a sub-paper discharge unit 212. The main paper feeding unit 102 side of the main image forming apparatus 100 is set to the upstream side of the sheet transport direction, and the sub-paper discharge unit 212 side of the sub-paper feeding unit 201 is set to the downstream side of the sheet transport direction. The sheet is one example of a medium on which an image may be formed. Hereinafter, a case in which the medium is a paper sheet will be described as an example.

The main image forming apparatus 100 includes a main scanning unit 101, the main paper feeding unit 102, amain resist roller 103, a visible image forming unit 104, a main transfer unit 105, a main fixing unit 106, a paper discharge unit 107, and a main control panel 108. In some embodiments, all, or a part, of each function of the main image forming apparatus 100 may be performed, using hardware such as an Application Specific Integrated Circuit (ASIC), a Programmable Logic Device (PLD), or a Field Programmable Gate Array (FPGA).

Each of the functional units of the main image forming apparatus 100 are disposed in an order along the sheet transportation direction of: the main paper feeding unit 102, the main resist roller 103, the main transfer unit 105, the main fixing unit 106, and the paper discharge unit 107. The sheet is transported on a transport path 120 in an order which goes along the disposal, and the sheet on which an image is formed is discharged from the main paper discharge unit 107. The discharged sheet is supplied to the sub-image forming apparatus 200. Hereinafter, functions provided in the main image forming apparatus 100 will be described.

The main scanning unit 101 is a scanner. The main scanning unit 101 reads an image from a sheet. The image read by the main scanning unit 101 is subjected to some predetermined processing by a control unit 110, and is then stored in a storage unit 111.

The main paper feeding unit 102 includes a tray and a roller. The main paper feeding unit 102 has sheets stacked on the tray. The main paper feeding unit 102 supplies a sheet from the tray to the main image forming apparatus 100 in order to form an image on the fed sheet. A paper feeding roller takes sheets from the tray sheet by sheet, and then feeds these sheets to the main image forming apparatus 100.

The main resist roller 103 is comprised of one or more rollers. The main resist roller 103 is driven by a main resistance driving unit 103a. The main resist roller 103 corrects an inclination angle of a fed sheet by temporarily receiving the tip end of the fed sheet. The main resist roller 103 supplies the sheet to the main transfer unit 105.

The visible image forming unit 104 is configured of a full color toner cartridge, a main photoconductive drum, amain charger, amain exposure device, amain developing device, and a main intermediate transfer element. The main intermediate transfer element is a transfer belt, for example. The full color toner cartridge is accommodates multiple toner cartridge units. The full color toner cartridge accommodates toner cartridge units of each color: yellow (21Y), magenta (21M), cyan (21C), and black (21K). The full color toner cartridge supplies toner to the main developing device. The main photoconductive drum is an image bearer, and is a cylindrical drum, for example. In the main photoconductive drum, a photoconductive material is disposed on the outer peripheral face, and the photoconductive material accumulates charges only at portions radiated with light. The main charger is a needle electrode, for example, and charges static electricity to the surface of the above described main photoconductive drum. The exposure device is a laser radiating device, for example, and forms an electrostatic latent image on the surface of the main photoconductive drum. The developing device supplies toner to the surface of the main photoconductive drum, and develops the electrostatic latent image using toner. The main intermediate transfer element is a looping belt, onto which toner image of each of the colors yellow (21Y), magenta (21M), cyan (21C), and black (21K) formed on the main photoconductive drum is transferred. The visible image forming unit 104 transfers the toner image of each of the colors yellow (21Y), magenta (21M), cyan (21C), and black (21K) to the main intermediate transfer element using the above described full color toner cartridge, the main photoconductive drum, the main charger, the main exposure device, and the main developing device.

The main transfer unit 105 includes a secondary transfer roller. The secondary transfer roller pushes the transported sheet to the above described main intermediate transfer element. The secondary transfer roller applies a positive voltage from the rear side of the transported sheet. The main transfer unit 105 transfers a toner image from the above described main intermediate transfer element to the transported sheet using the secondary transfer roller.

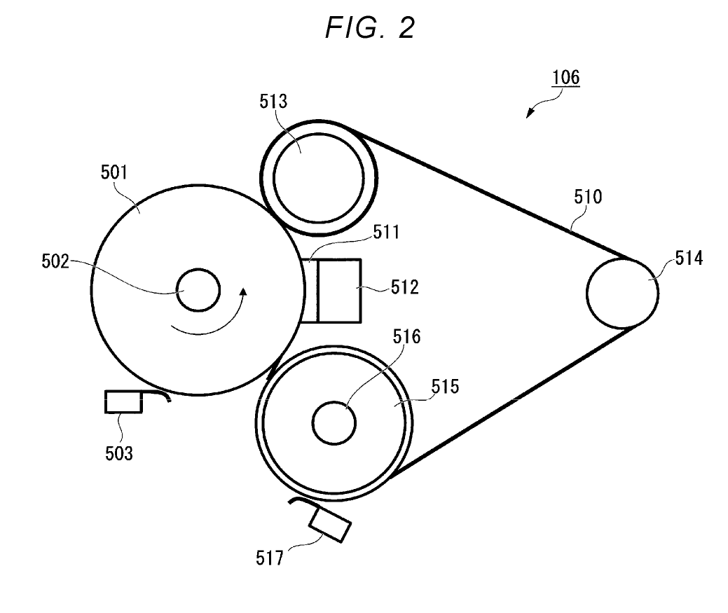

The main fixing unit 106 is a toner fixing device. FIG. 2 is a diagram which illustrates one possible example of a main fixing unit 106. The main fixing unit 106 includes a heating roller 501, an HR lamp 502, an HR thermistor 503, a press belt 510, a press pad 511, a pad holder 512, a press roller 513, a tension roller 514, a belt heating roller 515, a press belt lamp 516, and a press belt thermistor 517.

The heating roller 501 is a cylindrical fixing member. The HR lamp 502 is a heat generating element provided inside the heating roller 501. The HR lamp 502 may be configured of a halogen lamp, for example. The HR lamp 502 generates heat when turned on by the control unit 110. The HR lamp 502 heats the heating roller 501. The HR thermistor 503 measures a surface temperature of the heating roller 501.

The press belt 510 is held by the press roller 513, the tension roller 514, and the belt heating roller 515. The press belt 510 comes into pressuring contact with the heating roller 501 via the press pad 511 and the press roller 513. A fixing nip portion is formed between the press belt 510 and the heating roller 501

The press pad 511 is held in pressurizing contact with the heating roller 501 by the press belt 510. The pad holder 512 holds the press pad 511 in pressurizing contact with the heating roller 501.

The press roller 513 is disposed on the downstream side of a sheet along the transport direction. The press roller 513 causes the press belt 510 and the heating roller 501 to be in press contact. An exit of the fixing nip portion is formed by the press roller 513. The tension roller 514 applies a tension to the press belt 510 by being disposed at a position separated from the press roller 513 and the belt heating roller 515. The belt heating roller 515 is disposed on an ultrasonic sensor for detecting a sheet. The belt heating roller 515 is formed in a hollow cylindrical shape, for example. The press belt lamp 516 is provided inside the belt heating roller 515. The press belt lamp 516 heats the belt heating roller 515 by generating heat. The press belt lamp 516 is configured of a halogen lamp, for example. The press belt thermistor 517 measures a surface temperature of the press belt 510 in the vicinity of the belt heating roller 515.

Returning to descriptions in FIG. 1, the main paper discharge unit 107 includes rollers. The rollers of the main paper discharge unit 107 are rotated by a paper discharge driving unit 107a which is operated according to control of the control unit 110. The main paper discharge unit 107 moves the sheet or other medium for image forming along the transport direction when the rollers rotate. The main paper discharge unit 107 discharges the sheet/medium from the main image forming apparatus 100 using the main fixing unit 106.

The main control panel 108 includes a main display unit, a main operating unit, and a main display control unit, though they are not specifically illustrated. For example, the main display unit, the main operating unit, and the main display control unit are touch panel-type liquid crystal displays. The main display unit displays information related to the image forming system 1. The main operating unit generates control information of the apparatus according to an operation of a user. The main display control unit controls a display in the main display unit. The main operating unit may be configured of a push-type button(s), a dial-type button(s), or the like, instead of the touch panel type.

The main image forming apparatus 100 forms an image which has been read in the main scanning unit 101 from a sheet. The main image forming apparatus 100 transports the sheet from the main paper feeding unit 102 to the sub-image forming apparatus 200 through the transport path 120 in FIG. 1.

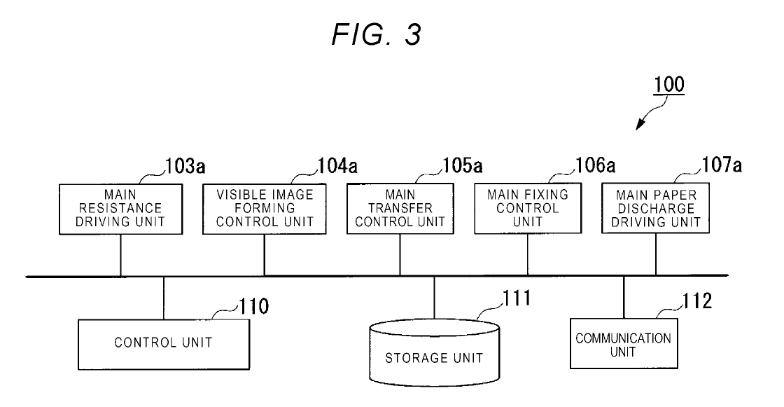

FIG. 3 is a block diagram which illustrates a functional configuration of the main image forming apparatus 100. The main image forming apparatus 100 includes the main resistance driving unit 103a, a visible image forming control unit 104a, a main transfer control unit 105a, a main fixing control unit 106a, a main paper discharge driving unit 107a, the control unit 110, the storage unit 111, and a communication unit 112. The main resistance driving unit 103a is a driving device such as a motor. The main resistance driving unit 103a rotates the main resist roller 103 by generating a driving force. The visible image forming control unit 104a controls an operation of the visible image forming unit 104 according to control of the control unit 110. The main transfer control unit 105a controls an operation of the main transfer unit 105 according to control of the control unit 110. The main fixing control unit 106a controls an operation of the main fixing unit 106 according to control of the control unit 110. The main paper discharge driving unit 107a is a driving device such as a motor. The main paper discharge driving unit 107a rotates a paper discharge roller of the main paper discharge unit 107 by generating a driving force. The control unit 110 controls operations of the functional units, which are connected through a bus, based on a predetermined control program. The storage unit 111 includes a storage device such as a magnetic hard disk device or a semiconductor storage device. The storage unit 111 stores data of an image read by the main scanning unit 101, or data of an image input from other information processing device from an information processing device. The communication unit 112 performs transceiving (transmitting & receiving) of data to/from another device. For example, the communication unit 112 may receive printing data including data of an image as a target of image forming. For example, the communication unit 112 may transmit printing data to the sub-image forming apparatus 200.

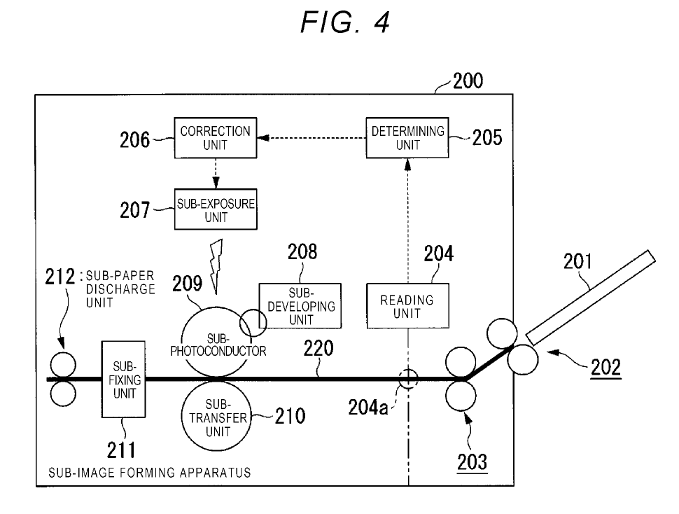

FIG. 4 is a configuration diagram which illustrates a configuration of the sub-image forming apparatus 200. The sub-image forming apparatus 200 includes a sub-paper feeding unit 201, a paper feeding roller 202, a sub-resist roller 203, a reading unit 204, a determining unit 205, a correction unit 206, a sub-exposure unit 207, a sub-developing unit 208, a sub-photoconductor 209, a sub-transfer unit 210, and a sub-fixing unit 211. The sub-image forming apparatus 200 includes a sub-control unit, though it is not specifically illustrated. All, or a part of the functions of the sub-image forming apparatus 200 may be executed using hardware such as an Application Specific Integrated Circuit (ASIC), a Programmable Logic Device (PLD), or a Field Programmable Gate Array (FPGA).

Each functional unit of the sub-image forming apparatus 200 is disposed in the following order of the sub-paper feeding unit 201, the paper feeding roller 202, the sub-resist roller 203, the sub-photoconductor 209, the sub-transfer unit 210, the sub-fixing unit 211, and the sub-paper discharge unit 212, along the sheet transport direction. A sheet is transported along the transport path 220 and the sheet on which an image is formed is discharged from the sub-paper discharge unit 212.

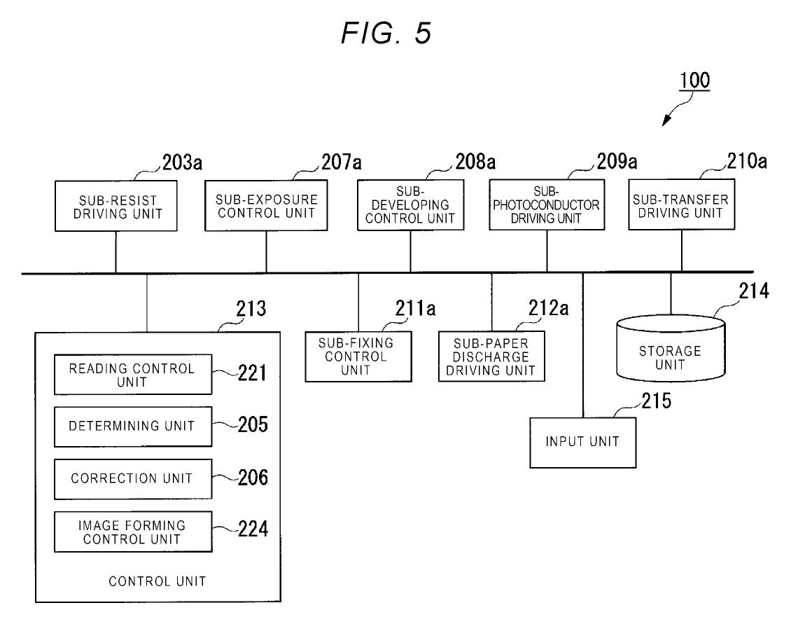

FIG. 5 is a schematic block diagram which illustrates a functional configuration of the sub-image forming apparatus 200. The sub-image forming apparatus 200 includes a sub-resist driving unit 203a, a sub-exposure control unit 207a, a sub-developing control unit 208a, a sub-photoconductor driving unit 209a, a sub-transfer driving unit 210a, a sub-fixing control unit 211a, a sub-paper discharge driving unit 212a, a control unit 213, a storage unit 214, and an input unit 215. The sub-resist driving unit 203a is a driving device such as a motor. The sub-resist driving unit 203a rotates the sub-resist roller 203 by receiving a supply of power, and generating a driving force. The sub-exposure control unit 207a controls an operation of the sub-exposure unit 207 according to control of the control unit 213 (image forming control unit 224). The sub-developing control unit 208a controls an operation of the sub-developing unit 208 according to control of the control unit 213 (image forming control unit 224). The sub-photoconductor driving unit 209a is a driving device such as a motor. The sub-photoconductor driving unit 209a rotates the sub-photoconductor 209 by generating a driving force. The sub-transfer driving unit 210a is a driving device such as a motor. The sub-transfer driving unit 210a rotates a roller of the sub-transfer unit 210 by receiving a supply of power, and generating a driving force. The sub-fixing control unit 211a controls an operation of the sub-fixing unit 211 according to control of the control unit 213 (image forming control unit 224). The sub-paper discharge driving unit 212a is a driving device such as a motor. The sub-paper discharge driving unit 212a rotates a paper discharge roller of the sub-paper discharge unit 212 by receiving a supply of power, and generating a driving force.

The control unit 213 functions as a reading control unit 221, the determining unit 205, the correction unit 206, and the image forming control unit 224 by being operated based on a predetermined program. The image forming control unit 224 controls an operation of each functional unit which is connected through a bus. The storage unit 214 is configured of a storage device such as a magnetic hard disk device or a semiconductor storage device. The storage unit 214 stores data of an image read by the reading unit 204, or data of an image input from other information processing device. The input unit 215 obtains image data as a target of image forming. Hereinafter, each function of the sub-image forming apparatus 200 will be described in detail.

The sub-paper feeding unit 201 is configured of a mechanism which holds a sheet, such as a belt, or a tray. A sheet discharged by the main paper discharge unit 107 of the main image forming apparatus 100 is transported to the sub-paper feeding unit 201. The transported sheet may be temporarily mounted on the tray of the sub-paper feeding unit 201.

The paper feeding roller 202 supplies a sheet to the sub-image forming apparatus 200 in order to form an additional image on a sheet which is held in the sub-paper feeding unit 201. Here, for example, the additional image may be considered to be a special color decorative image or the like provided to supplement the regular color portion of the image already formed on the sheet. The paper feeding roller 202 takes out the sheet held in the sub-paper feeding unit 201 sheet by sheet, and feeds the sheet to the sub-image forming apparatus 200.

The sub-resist roller 203 is configured of rollers. The sub-resist roller 203 is driven by the sub-resist driving unit 203a. The sub-resist roller 203 temporarily receives a tip end of a sheet supplied by the sub-paper feeding unit 201 and the paper feeding roller 202, and corrects an inclination of the sheet. The sub-resist roller 203 supplies the sheet to the sub-image forming apparatus 200.

The reading unit 204 is configured of an image sensor such as a contact image sensor (CIS). The reading unit 204 is disposed at a position at which it is possible to read the surface of a sheet as it passes between the sub-resist roller 203 and the sub-photoconductor 209. Preferably, the reading unit 204 is disposed at a position at which it is possible to read the surface of a sheet which has just passed through the sub-resist roller 203. However, the reading unit 204 may be disposed at any position when a timing for reading an image on the surface of a sheet is a timing at which image forming processing which will be performed with respect to the sheet thereafter is just in time. The reading unit 204 can perform a determination of whether or not there is a sheet, and also provide an image reading of the sheet. The reading unit 204 reads a sheet at a reading position 204a. The reading position 204a is a position on the sheet transport path 220. In the following descriptions, an image that is read by the reading unit 204 will be referred to as “the original image”. The image data read by the reading unit 204 is subjected to predetermined processing by the control unit 213 which will be described later, and is stored by the storage unit 214.

The determining unit 205 determines a writing timing of image data based on the original image as read by the reading unit 204. A determination result of the determining unit 205 is output to the image forming control unit 224. The image forming control unit 224 controls a rotation of the sub-resist roller 203 by controlling driving of the sub-resist driving unit 203a based on the determination result.

The correction unit 206 compares the original image as read by the reading unit 204 to image data used for printing this original image (hereinafter, this “image data” is referred to as a “source image”). The correction unit 206 corrects an image that is to be added (hereinafter, referred to as the “additional image”) according to the comparison between the original image, as read by the reading unit 204, and the source image. The correction unit 206 instructs the sub-exposure unit 207 to perform exposure(s) based on the additional image as corrected. Here, the source image and the input unit 215 will be described. The source image may be an image as read by the main scanning unit 101, for example. In addition, the source image may be an image provided as printing data from another information processing device. The input unit 215 can be configured using a communication interface which receives source image data through a data communication path. When the source image is an image that has been read by the main scanning unit 101, the input unit 215 receives source image data which is transmitted from the communication unit 112 of the main image forming apparatus 100 to the sub-image forming apparatus 200 through the data communication path. When the source image is image data provided from another information processing device, the input unit 215 receives source image data from another information processing device through the data communication path. Such a data communication path may be configured as a network connection, such as a local area network (LAN), or the Internet, for example, or may be formed using a wired cable, such as a universal serial bus (USB) cable.

Returning to descriptions of the correction unit 206, for the original image formed on the sheet, the sheet may contract due to heat from the fixing device (main fixing unit 106). The source image data as formed on the sheet thus becomes smaller than intended by the original image data due to contracting of the sheet, or the like, by heating. For this reason, a slight shift in size occurs between the image formed by the main image forming apparatus 100 and the additional image that would be formed based on the original image data without corresponding correction. Specifically, the image formed in the sub-image forming apparatus 200 might be larger in relation to the image formed on the sheet output from the main image forming apparatus 100. In order to reduce such a possible shift, the correction unit 206 corrects the size of the additional image to correspond to the actual image formed on the sheet as output from the main image forming apparatus. The correction unit 206 corrects the size of the additional image according to a ratio in size of the original image, as read by the reading unit 204, to the source image size.

The sub-exposure unit 207 includes an exposure device such as a laser radiating device. The sub-exposure unit 207 forms an electrostatic latent image corresponding to intended additional image information on the surface of the sub-photoconductor 209.

The sub-developing unit 208 includes a toner cartridge for transparent toner and/or a special color toner such as a gold color, a silver color, or the like. The sub-developing unit 208 supplies the above described special toner to the surface of the sub-photoconductor 209, and develops the electrostatic latent image using the above described special toner. It is generally preferable that a toner cartridge of a type different from that in the main image forming apparatus 100 be inserted into the sub-developing unit 208.

The sub-photoconductor 209 is an image bearer, and is configured of a columnar drum (hereinafter, referred to as “photoconductive drum”). A photoconductive material is disposed on the outer peripheral face of the photoconductive drum. The photoconductive material has a property of holding static electric charges in a dark (unexposed) state, and not in those portions upon which light is shone. The photoconductive drum rotates around a center axis in a predetermined direction. The sub-photoconductor 209 has an image developed by special color toner which was subjected to processing in the sub-exposure unit 207 and the sub-developing unit 208.

The sub-transfer unit 210 is configured of a transfer roller. The sub-transfer unit 210 transfers the image developed by the special color toner on the above described sub-photoconductor 209 to a sheet which is transmitted, at a predetermined transfer position.

The sub-fixing unit 211 is a fixing device. The sub-fixing unit 211 fixes the image transferred to the sheet in the sub-transfer unit 210 using heating or pressing, for example. A configuration of the sub-fixing unit 211 is the same as that in the main fixing unit 106 of the main image forming apparatus 100 as illustrated in FIG. 2.

Here, a flow of the sheet will be described, using FIGS. 1 and 4. First, the sheet fed from the main paper feeding unit 102 reaches the main resist roller 103 through the transport path 120. An inclination of the sheet is corrected, using the main resist roller 103. A toner image is transferred to the surface of the sheet, which has passed through the main resist roller 103, in the main transfer unit 105. After the sheet has passed through the main transfer unit 105, the toner image transferred to the surface thereof is fixed by being heated or pressed in the main fixing unit 106. At this time, moisture in the sheet evaporates due to the heating of the main fixing unit 106, and the sheet is thus dried. Due to the drying, the size of the sheet may be reduced. The sheet which has passed through the main fixing unit 106 is discharged to the outside of the main image forming apparatus 100 by the main paper discharge unit 107.

The sheet discharged from the main image forming apparatus 100 is then transported to a transport path 220 of the sub-image forming apparatus 200 via the sub-paper feeding unit 201 and the paper feeding roller 202 of the sub-image forming apparatus 200. The sheet which has entered the transport path 220 of the sub-image forming apparatus 200 next reaches the sub-resist roller 203. An inclination of the sheet is corrected by the sub-resist roller 203. The surface of the sheet which has passed through the sub-resist roller 203 is then read by the reading unit 204 at the reading position 204a. Thereafter, a special toner image formed on the surface of the sub-photoconductor 209 is transferred to the surface of the sheet using the sub-transfer unit 210. After the sheet has passed through the sub-transfer unit 210, the special toner image transferred to the surface thereof is fixed by being heated and pressed in the sub-fixing unit 211. The sheet which has passed through the sub-fixing unit 211 is then discharged to the outside of the sub-image forming apparatus 200 by the sub-paper discharge unit 212.

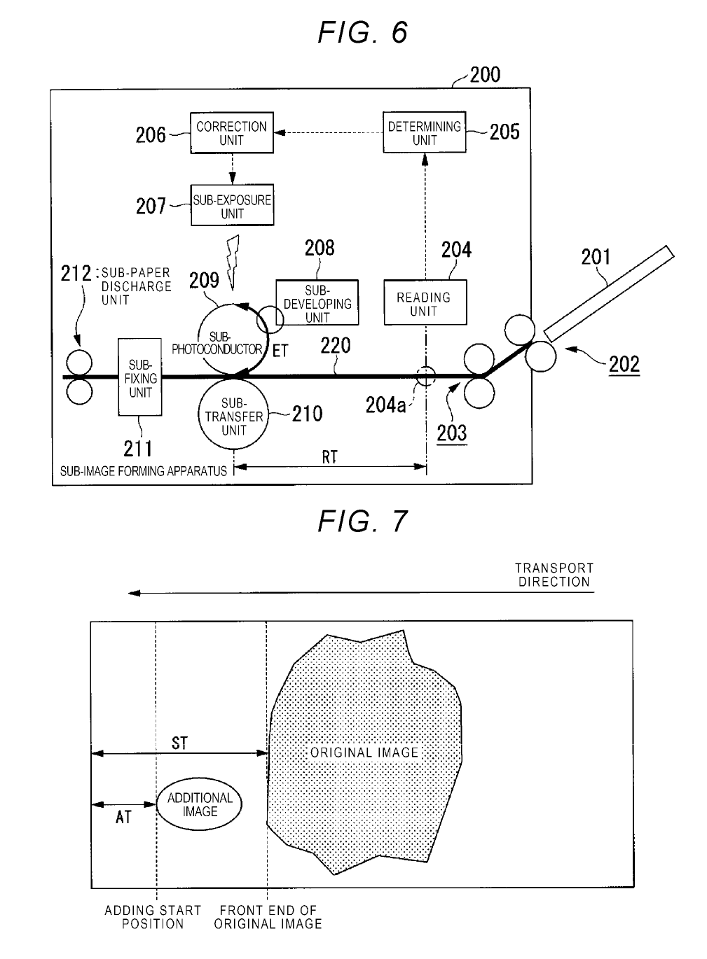

FIG. 6 illustrates the image forming distance ET and the transport distance RT which are defined in the sub-image forming apparatus 200.

The image forming distance ET is a distance in which a time TmE from a start of exposure with respect to the sub-photoconductor 209 by the sub-exposure unit 207 to a time in which an image is started to be transferred to a sheet (hereinafter, referred to as “image forming time”) is denoted by a speed v0 at which the sheet is transported. That is, ET=TmE×v0.

The transport distance RT is a distance from the reading position 204a to a transfer position. The transfer position is a position at which a toner image on the sub-photoconductor 209 is transferred to a sheet by the sub-transfer unit 210.

The sub-image forming apparatus 200 includes the sub-photoconductor 209, the sub-resist roller 203, and the sub-transfer unit 210 disposed such that RT>ET is satisfied when an additional image is formed at the back end (trailing edge) of the original image.

FIG. 7 illustrates a distance ST between a first position at which the reading unit 204 reads the original image (hereinafter, referred to as “front end of original image”) and a front end of a sheet, and a distance AT between a position at which an additional image is started to be formed on the sheet (hereinafter, referred to as “adding start position”) and the front end of the sheet. The values for ST, AT, and BT are used by the determining unit 205. Times for which the ST, AT and BT are divided by the speed v0 are set to TmS, TmA, and TmB.

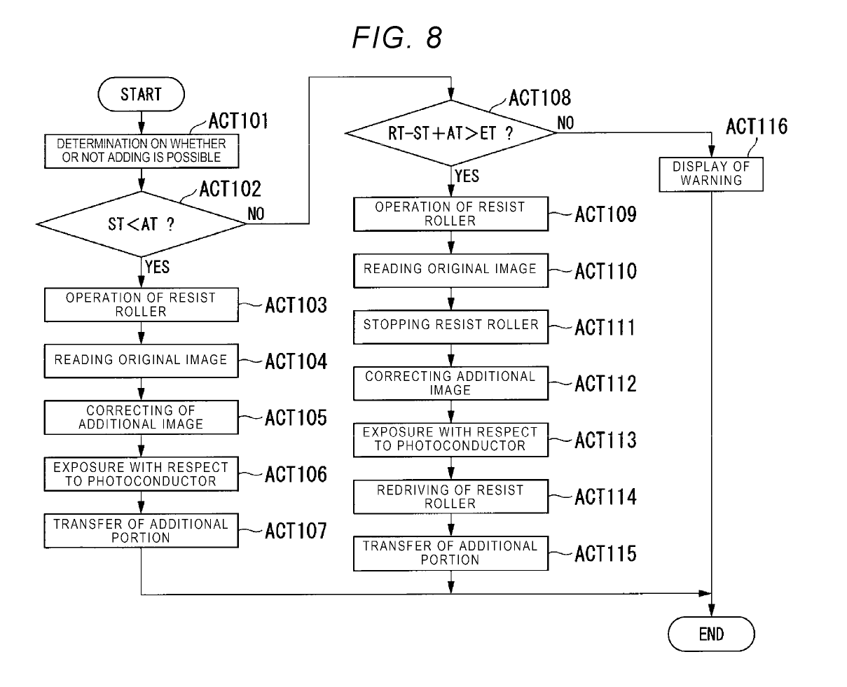

FIG. 8 is a flowchart which illustrates one possible example of a flow of processing in the sub-image forming apparatus 200. One possible example of an operation of the sub-image forming apparatus 200 when the additional image is formed at the back of the original image, when viewed along the transport direction, will be described, using FIG. 8.

First, the determining unit 205 determines whether or not adding is possible (ACT 101). For the determination on whether or not adding is possible, it is determined at which position between the front side and the rear side of the front end of the original image, the front end of the additional image would be located, based on information related to the additional image and the original image which is input through the input unit 215. In addition, the front end is an end portion which is located on the front side of the sheet along the transport direction, and in other words, an end portion located on the downstream side along the transport direction. That is, in ACT 101, the determining unit 205 determines whether or not ST<AT is satisfied. When ST<AT is satisfied (Yes in ACT 102), the sub-resist roller 203 is operated, and the sheet is transported (ACT 103). Subsequently, the reading unit 204 reads the original image at the reading position 204a (ACT 104). The correction unit 206 corrects the additional image based on the original image which has been read. The correction unit 206 instructs the sub-exposure unit 207 to perform exposure based on the image which is corrected (ACT 105). The sub-exposure unit 207 performs exposure with respect to the sub-photoconductor 209 according to the correction of the correction unit 206 (ACT 106). A toner image of the additional image is formed on the surface of the sub-photoconductor 209 according to the exposure with respect to the sub-photoconductor 209. In addition, the toner image formed on the sub-photoconductor 209 is transferred to the sheet using the sub-transfer unit 210 (ACT 107).

Subsequently, one possible example of an operation of the sub-image forming apparatus 200 when the additional image is formed in front of the original image when viewed along the transport direction will be described, using FIG. 8. In this case, exposure should be performed with respect to the sub-photoconductor 209 before the original image as a mark of an adding position of the additional image reaches the reading unit 204.

First, the determining unit 205 determines whether or not adding is possible (ACT 101). When ST<AT is satisfied (No in ACT 102), the determining unit 205 determines whether or not a time from reaching the reading position 204a of the front end of the original image to reaching the sub-transfer unit 210 of the adding start position is longer than the image forming time EmT. That is, the determining unit 205 determines whether or not (R−ST+AT)>ET is satisfied. When (RT−ST+AT)>ET is satisfied (Yes in ACT 108), the sub-resist roller 203 transports the sheet (ACT 109). When the front end of the original image reaches the reading position 204a, the reading unit 204 reads the original image which is formed on the medium for image forming (ACT 110). Subsequently, the image forming control unit 224 instructs the sub-resist driving unit 203a to decrease a rotation speed of the sub-resist roller 203. The sub-resist driving unit 203a decreases the rotation speed of the sub-resist roller 203. For example, the sub-resist driving unit 203a may decrease the rotation speed of the sub-resist roller 203 by decreasing a rotation speed of a motor (ACT 111). In addition, a stop of transporting is also included in decreasing of the transport speed. The correction unit 206 instructs the sub-exposure unit 207 to correct the additional image based on the original image which is read (ACT 112). The sub-exposure unit 207 performs exposure with respect to the sub-photoconductor 209 based on the corrected additional image (ACT 113). A toner image of the additional image is formed on the surface of the sub-photoconductor 209 according to the exposure of the sub-photoconductor 209. After starting of the exposure, the image forming control unit 224 controls a rotation of the sub-resist roller 203 so that the toner image of the sub-photoconductor 209 is transferred to a position of the additional image at the sub-transfer unit 210 by performing control of driving with respect to the sub-resist driving unit 203a (ACT 114). The sub-transfer unit 210 rotates according to driving of the sub-transfer driving unit 210a, and the toner image of the additional image formed on the sub-photoconductor 209 is transferred to the sheet (ACT 115).

When (RT−ST+AT)>ET is not satisfied in ACT 108 (No in ACT 108), the sub-image forming apparatus 200 outputs warning information which denotes that an accuracy of a position of the additional image is lowered. When the sub-image forming apparatus 200 includes a display unit, the determining unit 205 of the sub-image forming apparatus 200 may display the warning information in the display unit. When the sub-image forming apparatus 200 is not provided with a display unit, the determining unit 205 of the sub-image forming apparatus 200 may transmit the warning information to the main image forming apparatus 100 through a communication unit. In this case, the control unit 110 of the main image forming apparatus 100 which received the warning information may display the warning information on the main control panel 108 (ACT 116). An output of the warning information is not necessarily limited to a display of characters or an image on a display. For example, the output of the warning information may be performed as lighting of a lamp, or a sound output using a speaker.

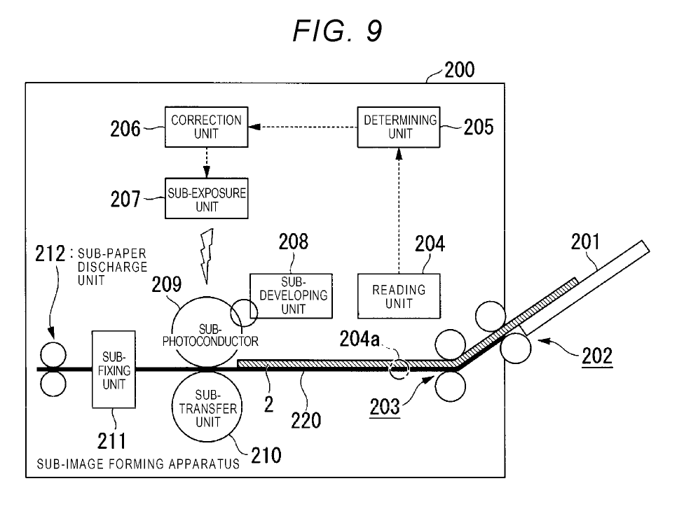

FIG. 9 illustrates a state in which a sheet 2 stops in front of the sub-transfer unit 210. The sheet in the above described ACT 111 stops immediately before the sub-transfer unit 210 across the sub-resist roller 203 as illustrated in FIG. 9.

### MODIFICATION EXAMPLE

The toner cartridge provided in the sub-image forming apparatus 200 may be a toner cartridge for full color(s), without being limited to a toner cartridge of a transparent toner and/or special toner of a gold color, a silver color, or the like.

Adding by plurality of special color toners may be performed by aligning a plurality of the sub-image forming apparatuses 200.

The main image forming apparatus 100 and the sub-image forming apparatus 200 may be communicably connected through a network such as a serial communication, a parallel communication, or a wireless communication. In this case, for example, the main image forming apparatus 100 and the sub-image forming apparatus 200 may be operated as follows. First, control data for image forming is transmitted to the main image forming apparatus 100 from an information processing device. The main image forming apparatus 100 determines an image of a toner image which can be formed, using the visible image forming unit 104 of the main image forming apparatus 100 based on the received control data for image forming. In addition, the main image forming apparatus 100 forms a toner image by controlling the visible image forming unit 104 based on the determination result, and transfers the toner image to a sheet. The main image forming apparatus 100 generates control data including data of an image (additional image) which denotes an image portion which is not formed by main image forming apparatus 100, and data of the source image, and transmits thereof to the sub-image forming apparatus 200. When receiving the control data, the sub-image forming apparatus 200 performs a correction with respect to an additional image based on data of the source image included in the received control data, and the original image read by the reading unit 204. The sub-image forming apparatus 200 transfers the corrected additional image to a sheet, and fixes thereof. At this time, the sheet on which an image is formed in the sub-image forming apparatus 200 may be given to the sub-image forming apparatus 200 from the main image forming apparatus 100, as described above, or maybe given to the sub-image forming apparatus 200 from the main image forming apparatus 100 by a person.

The sub-image forming apparatus 200 may be configured so as not to include any one, or both of the sub-paper feeding unit 201 and the paper feeding roller 202. In this case, a sheet may be directly transported to the transport path of the sub-image forming apparatus 200 from the main paper discharge unit 107 of the main image forming apparatus 100.

The sub-paper feeding unit 201 and the paper feeding roller 202 of the sub-image forming apparatus 200 may be integrally configured. That is, it may be a configuration in which the sub-paper feeding unit 201 includes the paper feeding roller.

According to at least one of the above described embodiments, it is possible to perform decorative printing at a low cost, by setting the image forming distance ET to be longer than the transport distance RT.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A secondary image forming apparatus, comprising:
a reading unit having a fixed reading position at which images on sheets moving along a sheet feeding path past the fixed reading position can be read, the reading unit being configured to read a sheet having a first image thereon and detect a position of the first image on the sheet;
a toner image transfer unit having a fixed transfer position on the sheet feeding path and configured to transfer a toner pattern to the sheet at the fixed transfer position, the toner pattern corresponding to a second image to be disposed on the sheet with the first image, the toner image transfer unit being downstream of the reading unit along the sheet feeding path; and
a control unit configured to calculate a timing for transfer of the toner pattern to the sheet by the toner image transfer unit according to detected position of the first image on the sheet, and control the toner image transfer unit according to the calculated timing.

2. The secondary image forming apparatus according to claim 1, wherein the control unit is further configured to
receive original image data used in forming the first image on the sheet, compare the position of the first image, as detected by the reading unit, to a position of the first image in the original image data, and adjust timing for the transfer of the toner pattern according to the comparison of the detected position of the first image and the position of the first image in the original image data.

3. The secondary image forming apparatus according to claim 2, wherein the timing for the transfer of the toner pattern is adjusted by decreasing a transport speed of the sheet along the sheet feeding path between the fixed reading position and the fixed transfer position.

4. The secondary image forming apparatus according to claim 2, wherein the control unit is further configured to output warning information when a calculated expected travel time for the sheet between a detection of a front end of the first image on the sheet at the fixed reading position to the fixed transfer position at which toner pattern corresponding to the second image is to be transferred to the sheet is greater than a time required for generating the toner pattern.

5. The secondary image forming apparatus according to claim 1, further comprising:
a sheet intake unit configured to receive the sheet directly from an external source and to align the sheet on the sheet transfer path.

6. The secondary image forming apparatus according to claim 5, wherein the external source is an image forming device capable of forming the first image on the sheet.

7. The secondary image forming apparatus according to claim 1, wherein the second image is to be placed on the sheet at a position between an edge of the sheet and the first image.

8. The secondary image forming apparatus according to claim 1, wherein the toner pattern is formed with one of a metallic color toner, a transparent toner, or a fluorescent toner.

9. An image forming system, comprising:
a secondary image forming apparatus according to claim 1; and
a primary image forming apparatus that forms the first image on the sheet, wherein
the secondary image forming apparatus is disposed adjacent to a sheet discharge position of the primary image forming apparatus.

10. The image forming system of claim 9, wherein the secondary image forming apparatus further comprises:
a sheet intake unit configured to receive the sheet after the sheet has been discharged from the primary image forming apparatus and to align the sheet on the sheet transfer path.

11. A secondary image forming apparatus, comprising:
a sheet feeding unit at which a sheet having a first image formed thereon can be received and placed on a sheet transfer path;
a reading unit configured to detect a position of the first image on the sheet;
an image forming unit including:
an exposure unit configured to form a latent electrostatic image on a photoconductor according to image data supplied to the image forming unit;
a developing unit configured to forma toner image on the photoconductor by developing the latent electrostatic image on the photoconductor;
a transfer unit configured to transfer the toner image on the photoconductor to the sheet; and
a fixing unit configured to fix the toner image transferred to the sheet to the sheet as a second image positioned relative to the first image on the sheet; and
a control unit configured to receive the position of the first image on the sheet as detected by the reading unit and calculate a timing for transfer of the toner image on the photoconductor to the sheet by the transfer unit, and control the image forming unit according to the calculated timing.

12. The secondary image forming apparatus according to claim 11, wherein the control unit is further configured to:
receive original image data used in forming the first image on the sheet, compare the position of the first image as detected by the reading unit to a position of the first image in the original image data, and adjust timing for the transfer of the toner image according to the comparison of the detected position of the first image and the position of the first image in the original image data.

13. The secondary image forming apparatus according to claim 12, wherein the timing for the transfer of the toner image is adjusted by decreasing a transport speed of the sheet along the sheet feeding path.

14. The secondary image forming apparatus according to claim 11, wherein the second image is to be placed on the sheet at a position between an edge of the sheet and the first image.

15. The secondary image forming apparatus according to claim 11, wherein the toner image is formed with one of a metallic color toner, a transparent toner, or a fluorescent toner.

16. An image forming system, comprising:
a secondary image forming apparatus according to claim 11; and
a primary image forming apparatus that forms the first image on the sheet, wherein
the secondary image forming apparatus is disposed adjacent to a sheet discharge position of the primary image forming apparatus.

17. An image forming system, comprising:
a primary image forming apparatus configured to form a first image on a sheet and discharged the sheet with the first image formed thereon; and
a secondary image forming apparatus including:
a sheet feeding unit at which the sheet having the first image formed thereon can be received and placed on a sheet transfer path;
a reading unit configured to detect a position of the first image on the sheet;
an image forming unit including:
an exposure unit configured to forma latent electrostatic image on a photoconductor according to image data supplied to the image forming unit;
a developing unit configured to forma toner image on the photoconductor by developing the latent electrostatic image on the photoconductor;
a transfer unit configured to transfer the toner image on the photoconductor to the sheet; and
a fixing unit configured to fix the toner image transferred to the sheet to the sheet as a second image positioned relative to the first image on the sheet;
a control unit configured to receive the position of the first image on the sheet as detected by the reading unit and calculate a timing for transfer of the toner image on the photoconductor to the sheet by the transfer unit, and control image forming unit according to the calculated timing.

18. The image forming system according to claim 17, wherein the control unit of the secondary image forming apparatus is further configured to:
receive original image data used in forming the first image on the sheet, compare the position of the first image as detected by the reading unit to a position of the first image in the original image data, and adjust timing for the transfer of the toner image according to the comparison of the detected position of the first image and the position of the first image in the original image data

19. The image forming system according to claim 18, wherein the original image data is received from the primary image forming apparatus.

20. The image forming system according to claim 17, wherein
the primary image forming apparatus is configured to form the first image using at least one of cyan, magenta, yellow, and black toner, and
the secondary image forming apparatus is configured to form the second image using at least one of a metallic color toner, a transparent toner, and a fluorescent toner.
